(19) United States
(12) Patent Application Publication
(10) Pub. No.: US 2015/0294516 A1
(43) Pub. Date: Oct. 15, 2015

(54) ELECTRONIC DEVICE WITH SECURITY MODULE

(71) Applicant: Kuo-Ching CHIANG, Taipei City (TW)

(72) Inventor: Kuo-Ching CHIANG, Taipei City (TW)

(21) Appl. No.: 14/250,383

(22) Filed: Apr. 10, 2014

(51) Int. Cl. G07C 9/00; G06F 3/044

(52) U.S. Cl. CPC G07C 9/00158; G06F 3/044

(57) ABSTRACT

The present invention provides a security method for an electronic device includes providing the electronic device with a security mode and an operation mode, wherein the electronic device includes a touch panel having a sensing array. A sample fingerprint is fetched by using the sensing array; a detected fingerprint is fetched by sensing a fingerprint using the sensing array in the security mode. The sample fingerprint is compared with the detected fingerprint in the security mode, followed by unlocking the electronic device if the detected fingerprint matches with the sample fingerprint, and switch the electronic device into the operation mode. A control signal is generated in responsive to a touching event, followed by controlling a virtual object displayed on a display in responsive to the control signal.

### TECHNICAL FIELD

The present invention relates generally to a portable device, and more particularly to an electronic device with security module.

### BACKGROUND OF RELATED ART

Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone.

A fingerprint sensor is an electronic device used to capture a digital image of the fingerprint pattern. Optical fingerprint imaging involves capturing a digital image of the print using visible light. This type of sensor is, in essence, a specialized digital camera. The top layer of the sensor, where the finger is placed, is known as the touch surface. Ultrasonic sensors make use of the principles of medical ultrasonography in order to create visual images of the fingerprint. The device requires large arrays for touch input and currently, a fingerprint security device is also provided adjacent to the touch panel, typically, the fingerprint security device is formed of CMOS sensor which is made by the semiconductor method.

### SUMMARY

The object of the present invention is to omit the additional CMOS fingerprint sensor.

The present invention provides a portable device comprising: a control unit; a display coupled to the control unit; a dual wireless module coupled to the control unit for wireless data transferring, wherein the dual wireless module includes a first and a second wireless data transferring modules to allow a user to select desired one to communicate with an external device.

A security method for an electronic device includes providing the electronic device with a security mode and an operation mode, wherein the electronic device includes a touch panel having a sensing array. A sample fingerprint is fetched by using the sensing array; a detected fingerprint is fetched by sensing a fingerprint using the sensing array in the security mode. The sample fingerprint is compared with the detected fingerprint in the security mode, followed by unlocking the electronic device if the detected fingerprint matches with the sample fingerprint, and switch the electronic device into the operation mode. A control signal is generated in responsive to a touching event, followed by controlling a virtual object displayed on a display in responsive to the control signal.

The sensing array includes a capacitance sensing array. The sample fingerprint includes a sample capacitance pattern; the detected fingerprint includes a detected capacitance pattern. The electronic device includes a gesture application; the gesture application is disable in the security mode. The gesture application is enable in the operation mode.

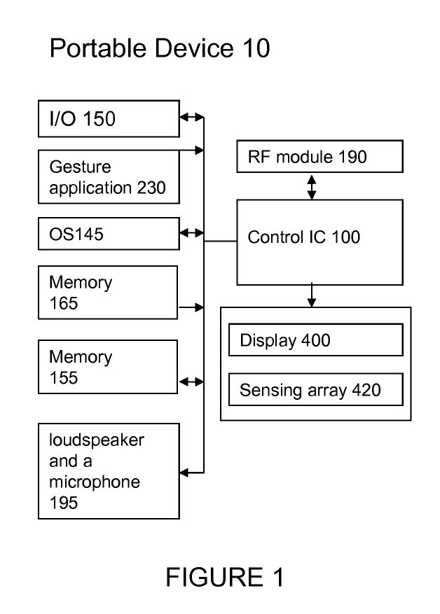

FIG. 1 shows a diagram of a portable device according to the present invention.

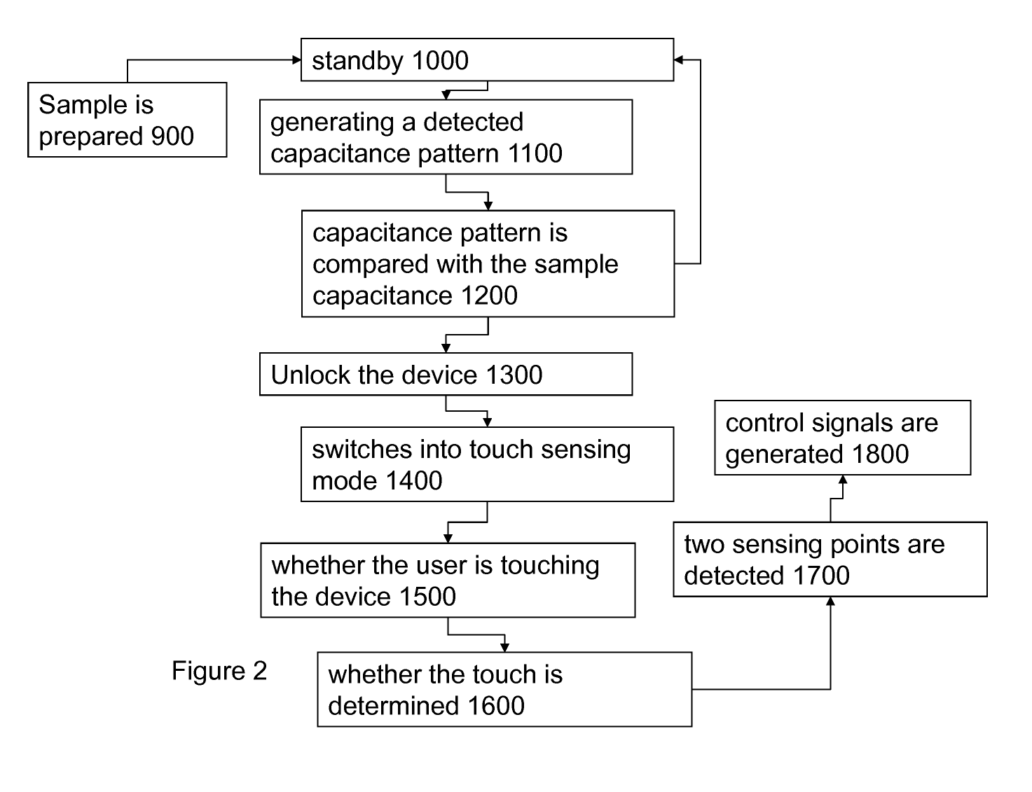

FIG. 2 shows a flow chart according to the present invention.

### DETAILED DESCRIPTION

The present invention relates generally to a computing or portable device. The device includes but not limited to cellular phone, PDA (personal digital assistant), smart phone, notebook, digital still camera, digital video camera, medium player (MP3, MP4), GPS, tablet and the equivalent thereof. FIG. 1 is a diagram illustrating main components of a portable communication device having a touch panel according to an embodiment of the present invention. The embodiment, as shown in FIG. 1, the device 10 includes a RF module 190. As known in the art, the RF module 190 includes antenna. This antenna is connected to a transceiver, which is used to receive and transmit signal. AS known, the RF module 190 further includes CODEC, DSP and A/D converter as well. Due to the RF module is not the feature of the present invention, therefore, the detailed description is omitted. The present invention includes a central control IC 100, an input and output (I/O) unit 150, OS 145, a memory 165, the device 10 may include other memory 155 such as ROM, RAM and FLASH memory. The RF module may perform the function of signal transmitting and receiving, frequency synthesizing, base-band processing and digital signal processing. If the portable device is cellular, SIM card hardware interface is provided for receiving a SIM card. Finally, the signal is send to the final actuators, i.e. a loudspeaker and a microphone 195 or I/O 150.

The present invention further includes a wireless transmission/receiving module (no shown) coupled to the control IC 100. The transmission/receiving module is compatible with blue-tooth, home-RF, 802.11x, WiFi, WiMAX standard or their higher version. The transmission domain (the air) by nature is not secured and therefore encryption maybe essential in the wireless transport networks. In one embodiment, pair-wise encryption/decryption between every neighboring wireless network device of a wireless transport network is well-known in the art. A data frame that leaves from one wireless device from one end of a wireless transport network to the other end of the same network might need several encryptions and decryptions before it reaches its final destination. An operating system runs on CPU, provides control and is used to coordinate the function of the various components of system and Application programs. A program is set up in the device to use the electrical signals to control functions and/or functions controlled by the device.

The portable electronic device is, for example cellular phones, PDAs, media players, and GPS, or notebook, Tablet PCs and game players. The portable electronic device is configured with a sensor array on the display. The sensor array is configured to detect the presence of an object such as a finger as well as the location being exerted on the surface of the panel by the finger or palm of the hand. By way of example, the sensor array may be based on capacitive sensing. Typically, the sensing array includes an x-electrode array and y-electrode array to sense the x axis and y axis touching evens to determines the touching position.

The portable electronic device includes a housing and a display 400 situated in a front surface of the housing. The portable electronic device also includes a touch sensing array 420 situated on the display. FIG. 1 is a perspective diagram of a hand held electronic device in accordance with one embodiment of the present invention. The hand held electronic device includes a housing that encloses internally various electrical components including integrated circuit chips. The hand held electronic device also includes a display disposed within and viewable through an opening in the housing. The display provides visual information in the form of text, characters or graphics. In order to generate user inputs, the hand held electronic device may include a sensing array that is a transparent input panel positioned in front of the display. The sensing array generates input signals when an object such as a finger is moved across the surface of the sensing array, for example linearly, radially, rotary, etc., from an object holding a particular position on the array and/or by a finger tapping on the array. In most cases, the sensing array allows a user to initiate movements in a GUI by simply touching the display screen via a finger. For example, the sensing array recognizes the touch and position of the touch on the display and an interpreting controller of the hand held electronic device interprets the touch and thereafter performs an action based on the touch event. In accordance with one embodiment, the sensing array is a multi-touch sensing device that has the ability to sense multiple points of contact at the same time and report the multiple touches to the controller of the handheld electronic device. In one implementation, the sensing array is a multipoint capacitive touch screen that is divided into several independent regions. The sensing points, which are typically transparent, are dispersed about the sensing array with each sensing point representing a different position on the surface of the display. The sensing points may be positioned in a grid or a pixel array where each pixilated sensing point is capable of generating a signal. The signal is produced each time an object is positioned over a sensing point. When an object is placed over multiple sensing points, multiple signals can be generated. The sensing points generally map the touch screen plane into a coordinate system such as a Cartesian coordinate system or a Polar coordinate system.

The hand held electronic device may be designed to recognize gestures applied to the sensing array 420 and to control aspects of the hand held electronic device based on the gestures. The gestures may be made through various particularly finger motions. The hand held electronic device may include a gesture operational program (application) 230, which may be part of the operating system or a separate application. The gestural operation program 230 generally includes a set of instructions that recognizes the occurrence of gestures and informs one or more software agents of the gestures and/or what action(s) to take in response to the gestures.

In one embodiment, the sensing input device is mapped to the display. When mapped, points on the sensing input device coincide with points on the display, i.e., have the same coordinates (x and y). Therefore, when a user touches the sensing input device surface, it will appear as if the user is touching the image at the same location of the display. As shown, the sensing array is divided into several independent and spatially distinct sensing points (or regions) that are positioned within the respective component. The sensing points are generally dispersed about the respective component with each sensing point representing a different position on the surface of the component. The number and configuration of sensing points generally depends on the desired resolution of the touch sensitive surface. In the case, a signal is produced each time the finger is positioned over a sensing point. As should be appreciated, the number, combination and frequency of signals in a given time frame may indicate size, location, direction, speed, acceleration and the pressure of the finger or palm on the surface of the device. By way of example, the control system may be a microcontroller located within the housing of the device.

The signals generated at the sensing points may be used to determine how the user would like to move the web page or virtual object displayed on the display. By way of example, each portion of the hand in contact with the device produces a contact patch area. Each of the contact patch areas covers several sensing points thus generating several signals. The signals may be grouped together to form a signal that represents how the user is moving the virtual object or page. In one embodiment, the difference between a current signal and a last hand signal may indicate the user's desire to implement a function of moving web-page. Changes between contact patch areas may further indicate the particular moving signal. The touch surface is divided into one or more button zones that represent regions of the device that when selected implement the particular button function associated with the button zone. The position and size of the button zones may also be customizable. For example, page back, page next and so on. The customization may be performed by the user and/or the device.

The finger has fingerprint, fingerprints are the traces of an impression from the friction ridges of any part of a human or other primate hand. Fingerprints are one of many forms of biometrics used to identify individuals and verify their identity. A friction ridge is a raised portion of the epidermis on the digits. These are sometimes known as “epidermal ridges. When, the finger locates on the capacitor sensor, for example, on the touch panel. The fingerprint will cause different capacitance in different points due to the pattern of the fingerprint. Capacitance sensors use principles associated with capacitance in order to form fingerprint images. In this method of imaging, the sensor array pixels each act as one plate of a parallel-plate capacitor, the dermal layer (which is electrically conductive) acts as the other plate, and the non-conductive epidermal layer acts as a dielectric. A passive capacitance sensor use the principle outlined above to form an image of the fingerprint patterns on the dermal layer of skin. Each sensor pixel is used to measure the capacitance at that point of the array. The capacitance varies between the ridges and valleys of the fingerprint due to the fact that the volume between the dermal layer and sensing element in valleys contains an air gap. The dielectric constant of the epidermis and the area of the sensing element are known values. The measured capacitance values are then used to distinguish between fingerprint ridges and valleys. When in the mode of recognition or sample (template) fetching mode, the gesture application is off (disable), the security module records the capacitance pattern caused by the fingerprint. Therefore, the sample of the fingerprint is fetched. Each of the contact patch areas covers several sensing points thus generating several signals. The signals may be grouped together to form a signal that represents the fingerprint pattern. The electronic device is provided with a control unit and a touch panel having a sensing array which is coupled to the control unit, wherein the electronic device includes a security mode and an operation mode coupled to the control unit.

FIG. 2 is an operational method in accordance with one embodiment of the present invention. In step 900, the finger print sample or template is prepared by sensing the finger capacitance pattern by disable the gesture application. The method generally begins at block 1000 where the device is in standby. The device is in security mode, no one can operate the device without the fingerprint. In the security mode, the gesture application is not-activated or disable (off), the security module fetched the capacitance of each points of the finger, thereby generating a detected capacitance pattern in block 1100. The capacitance pattern is compared with the sample capacitance to determine whether lock or unlock the device in 1200. If it is matched, the device is unlocked 1300. After unlock the device such as cellular, it switches into an operational mode or touch sensing mode, and it standbys for signal input 1400, and the gesture application is enable or activated, standby generally implies that the device is in a state of readiness waiting for something to happen, i.e., a user initiating an action therewith. Following block 1400, the process flow proceeds to block 1500 where a determination is made as to whether the user is touching the device. This is generally accomplished with touch sensing device capable of generating signals when a hand nears the device and a control system configured to monitor the activity of the touch sensing device. If it is determined that the user is not touching the device, then the process flow proceeds back to block 1400 thereby keeping the device in standby. If it is determined that the user is touching the device, then the process flow proceeds to block 1600 where the touched is determined.

In one embodiment, once the second location is determined, the process flow proceeds to block 1700, at least two sensing points signals are detected by the controller. Following block 1700 the process flow proceeds to block 1800, where touch events are monitored, control signals are generated based on the touch event. The control signals may be used to inform the application software within the device to move the virtual object or page displayed on the screen instead of by moving the page by keys, cursor or touch pen.

The processor can be implemented on a single-chip, multiple chips or multiple electrical components. For example, various architectures can be used for the processor, including dedicated or embedded processor, single purpose processor, controller, ASIC, and so forth. In most cases, the processor together with an operating system operates to execute computer code and produce and use data. The operating system may correspond to well known operating systems such as OS/2, DOS, Unix, Linux, and Palm OS. Memory provides a place to store computer code, the memory may include Read-Only Memory (ROM), Random-Access Memory (RAM), hard disk drive, flash memory and/or the like. The display is generally configured to display a graphical user interface (GUI) that provides an easy to use interface between a user of the electronic device and the operating system or application running thereon. The electronic device also includes a touch screen that is operatively coupled to the processor. The touch screen is configured to transfer data from the outside into the device. The electronic device also includes a sensing device that is operatively coupled to the processor. The sensing device may also be used to issue web page moving commands.

Examples of hand held devices include PDAs, Cellular Phones, Media player, Game players, Cameras, GPS receivers and the like. Therefore, the user may move the web page, image or document displayed on the page by directly moving the finger on the sensing array. The user may move the web-page, text, image, icon shown on the display directly by hand or user finger.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention.

I claim:

1. A security method for an electronic device comprising:
providing said electronic device with a control unit and a touch panel having a sensing array coupled to said control unit, wherein said electronic device includes a security mode and an operation mode coupled to said control unit;
fetching a sample fingerprint by using said sensing array;
fetching a detected fingerprint by sensing a fingerprint using said sensing array in said security mode;
comparing said sample fingerprint with said detected fingerprint in said security mode;
unlocking said electronic device if said detected fingerprint matches with said sample fingerprint, and switch said electronic device into said operation mode;
generating a control signal in responsive to a touching event; and
controlling a virtual object displayed on a display in responsive to said control signal.

2. The method of claim 1, wherein said sensing array includes a capacitance sensing array.

3. The method of claim 2, wherein said sample fingerprint includes a sample capacitance pattern.

4. The method of claim 2, wherein said detected fingerprint includes a detected capacitance pattern.

5. The method of claim 1, wherein said electronic device includes a gesture application.

6. The method of claim 5, wherein said gesture application is disable in said security mode.

7. The method of claim 5, wherein said gesture application is enable in said operation mode.

8. A security method for an electronic device comprising:
providing said electronic device with a control unit and a touch panel having a sensing array coupled to said control unit, wherein said electronic device includes a security mode and an operation mode coupled to said control unit;
fetching a detected fingerprint by sensing a fingerprint using said sensing array in said security mode;
comparing said detected fingerprint with a template in said security mode;
unlocking said electronic device if said detected fingerprint matches with said template, and switch said electronic device into said operation mode;
generating a control signal in responsive to a touching event; and
controlling a virtual object displayed on a display in responsive to said control signal.

9. The method of claim 8, wherein said sensing array includes a capacitance sensing array.

10. The method of claim 9, wherein said sample fingerprint includes a sample capacitance pattern.

11. The method of claim 9, wherein said detected fingerprint includes a detected capacitance pattern.

12. The method of claim 8, wherein said electronic device includes a gesture application.

13. The method of claim 12, wherein said gesture application is disable in said security mode.

14. The method of claim 12, wherein said gesture application is enable in said operation mode.

15. The method of claim 8, further comprising fetching said template by using said sensing array.
